(19) United States
(12) Patent Application Publication
(10) Pub. No.: US 2026/0262722 A1
(43) Pub. Date: Sep. 10, 2026

(54) VAPOR GENERATION DEVICE, HEATER FOR VAPOR GENERATION DEVICE, AND MANUFACTURING METHOD

(71) Applicant: SHENZHEN FIRST UNION TECHNOLOGY CO., LTD., Shenzhen City, Guangdong Province (CN)

(72) Inventors: JIAN WU, Shenzhen City, Guangdong Province (CN); ZHONGLI XU, Shenzhen City, Guangdong Province (CN); YONGHAI LI, Shenzhen City, Guangdong Province (CN)

(21) Appl. No.: 18/567,018

(22) PCT Filed: Jun. 2, 2022
(86) PCT No.: PCT/US2022/096910

§ 371 Date: Dec. 4, 2023

(30) Foreign Application Priority Data
Jun. 4, 2021 (CN) 202110626465.8

(51) Int. Cl. A24F 40/46; A24F 40/20; A24F 40/70; H05B 3/03

(52) U.S. Cl. CPC A24F 40/46; A24F 40/70; H05B 3/03; A24F 40/20

(57) ABSTRACT

This application provides a vapor generation device, a heater for a vapor generation device, and a manufacturing method. The vapor generation device includes: a cavity, configured to receive an aerosol-forming article; and a heater, at least partially extending in the cavity, and configured to heat the aerosol-forming article, where the heater includes: a shell, having a hollow extending in an axial direction; a resistor heating element, located in the hollow; and an insulator, formed by a molten precursor material solidified or cured in the hollow, and configured to provide electrical insulation between the resistor heating element and the shell. In the foregoing vapor generation device, the insulator is formed through solidification after melting, and the insulator can be completely permeated to a gap or an interval between an inner wall of the shell of the heater and the resistor heating element.

### CROSS-REFERENCE TO RELATED APPLICATIONS

This application claims priority to Chinese Patent Application No. 202110626465.8, filed with the China National Intellectual Property Administration on Jun. 4, 2021 and entitled “VAPOR GENERATION DEVICE, HEATER FOR VAPOR GENERATION DEVICE, AND MANUFACTURING METHOD”, which is incorporated herein by reference in its entirety.

### TECHNICAL FIELD

Embodiments of this application relate to the field of heat-not-burn cigarette device technologies, and in particular, to a vapor generation device, a heater for a vapor generation device, and a manufacturing method.

### BACKGROUND

Tobacco products (such as cigarettes, cigars, and the like) burn tobacco during use to produce tobacco smoke. Attempts are made to replace these tobacco-burning products by making products that release compounds without burning.

An example of this type of products is a heating device that releases compounds by heating rather than burning materials. For example, the materials may be tobacco or other non-tobacco products. These non-tobacco products may include or not include nicotine. In the known technology, Patent No. 202010054217.6 proposes encapsulation of a heater with a spiral heating wire in a metal outer sleeve tube to heat a tobacco product to generate an aerosol. For the foregoing heater, insulation between the spiral heating wire and the metal outer sleeve tube is usually implemented by filling an inorganic insulating adhesive or filling an inorganic powder material in the metal outer sleeve tube. In addition to an inevitable powder leakage problem or the like, a large number of pores affect transfer of heat between the heating wire and the outer sleeve tube.

### SUMMARY

An embodiment of this application provides a vapor generation device, configured to heat an aerosol-forming article to generate an aerosol, and including:
a cavity, configured to receive the aerosol-forming article; and
a heater, at least partially extending in the cavity, and configured to heat the aerosol-forming article, where the heater includes:
a shell, having a hollow extending in an axial direction;
a resistor heating element, located in the hollow; and
an insulator, formed by a molten precursor material solidified or cured in the hollow, and configured to provide electrical insulation between the resistor heating element and the shell.

In a preferred implementation, the shell includes a metal or an alloy.

In a preferred implementation, a melting point of the precursor material forming the insulator ranges from 400° C. to 1500° C.

In a preferred implementation, the melting point of the precursor material is lower than a melting point of the shell.

In a preferred implementation, the insulator includes glaze or glass or silicon dioxide.

In a preferred implementation, the resistor heating element is configured into a form of a spiral coil extending in the axial direction of the hollow; and
a cross section of a wire material of the spiral coil is configured into a flat shape.

In a preferred implementation, the cross section of the wire material of the spiral coil is configured with a length extending in an axial direction of the spiral coil being greater than a length extending in a radial direction.

In a preferred implementation, the insulator is configured to keep the resistor heating element in the hollow.

In a preferred implementation, the resistor heating element is wrapped in the insulator.

In a preferred implementation, the resistor heating element has a metal oxide layer formed through surface oxidation.

In a preferred implementation, the insulator includes at least one of aluminum oxide or a precursor thereof, silicon dioxide or a precursor thereof, aluminate, aluminosilicate, aluminum nitride, aluminum carbide, zirconium dioxide, silicon carbide, silicon boride, silicon nitride, titanium dioxide, titanium carbide, boron carbide, boron oxide, borosilicate, silicate, rare earth oxide, soda lime, barium titanate, lead zirconate titanate, aluminum titanate, barium ferrite, strontium ferrite, or this type of inorganic materials.

Still another embodiment of this application further provides a heater for a vapor generation device. The heater includes:
a shell, including a metal or an alloy, where the shell is configured into a pin or needle, and has a hollow extending in an axial direction;
a resistor heating element, located in the hollow; and
an insulator, formed by a molten precursor material solidified or cured in the hollow, and configured to provide electrical insulation between the resistor heating element and the shell.

Still another embodiment of this application further provides a manufacturing method of a heater for a vapor generation device, including the following steps:
obtaining shell and a resistor heating element, where the shell has a hollow extending in an axial direction; and
solidifying or curing a molten precursor material in the hollow, to provide electrical insulation between the shell and the resistor heating element.

In a preferred implementation, the step of solidifying or curing a molten precursor material in the hollow includes:
adding the precursor material to the hollow of the shell, and heating the precursor material to a molten state; and
immersing the resistor heating element in the precursor material in the molten state, and solidifying the precursor material in the molten state through cooling.

In a preferred implementation, before the immersing the resistor heating element in the precursor in the molten state, the method further includes:
forming a metal oxide layer on a surface of the resistor heating element.

In a preferred implementation, power is supplied to the resistor heating element in an air or oxygen atmosphere to enable the resistor heating coil to generate heat, to form the metal oxide layer the surface of the resistor heating element.

In another preferred implementation, the resistor heating element is heated in an air or oxygen atmosphere, to form the metal oxide layer the surface of the resistor heating element.

In still another preferred implementation, an insulating material layer is sprayed or deposited or formed on the surface of the resistor heating element. For example, the insulating material layer is a glaze layer.

In the foregoing vapor generation device, the insulator is formed through solidification after melting, and the insulator can be completely permeated to a gap or an interval between an inner wall of the shell of the heater and the resistor heating element, so that basically complete insulation is achieved between the shell and the resistor heating element. In addition, the consistency and yield of insulation in mass production and manufacturing can be improved.

### BRIEF DESCRIPTION OF THE DRAWINGS

One or more embodiments are exemplarily described with reference to the corresponding figures in the accompanying drawings, and the descriptions do not constitute a limitation to the embodiments. Components in the accompanying drawings that have same reference numerals are represented as similar components, and unless otherwise particularly stated, the figures in the accompanying drawings are not drawn to scale.

FIG. 1 is a schematic structural diagram of a vapor generation device according to an embodiment of this application;

FIG. 2 is a schematic cross-sectional view of an embodiment of a heater in FIG. 1;

FIG. 3 is a schematic structural diagram of a shell of the heater in FIG. 2 from a viewing angle;

FIG. 4 is a schematic structural diagram of a resistor heating element in FIG. 2 from a viewing angle;

FIG. 5 is a schematic cross-sectional view of a resistor heating coil in FIG. 4 from a viewing angle;

FIG. 6 is a schematic structural diagram of a resistor heating element according to another embodiment;

FIG. 7 is a schematic diagram of a manufacturing method of a heater according to an embodiment;

FIG. 8 is a schematic diagram of a precursor forming a molten state in a shell of a heater according to an embodiment;

FIG. 9 is a schematic diagram of a precursor entering a molten state of a resistor heating element according to an embodiment;

FIG. 10 is a temperature change curve of a heater in use according to an embodiment;

FIG. 11 is a temperature change curve of a heater in use in a comparative example; and

FIG. 12 is a temperature change curve of a heater in use in another comparative example.

### DETAILED DESCRIPTION

For ease of understanding of this application, this application is described in further detail below with reference to the accompanying drawings and specific implementations.

An embodiment of this application provides a vapor generation device. For the construction of the device, refer to FIG. 1. The device includes:
a cavity, where an aerosol-forming article A is removably received in the cavity;
a heater 30 at least partially extending in the cavity, and inserted into the aerosol-forming article A to perform heating when the aerosol-forming article A is received in the cavity, to enable the aerosol-forming article A to release various volatile compounds, where these volatile compounds are only formed through heating;
a battery cell 10, configured to supply power; and
a circuit 20, configured to guide a current between the battery cell 10 and the heater 30.

In a preferred embodiment, the heater 30 generally has a pin or needle shape, which facilitates insertion into the aerosol-forming article A. In addition, the heater 30 may have a length of approximately 12 millimeters to 19 millimeters, and an outer diameter of approximately millimeters 2 to 4 millimeters.

In a further optional implementation, the aerosol-forming article A is preferably a tobacco-containing material that releases a volatile compound from a substrate during heating; or may be a non-tobacco material that can be appropriate for electrical heating and smoke generation after heating. The aerosol-forming article A is preferably a solid substrate, and may include one or more of powder, particles, shreds, strips, or sheets of one or more of herb leaves, tobacco leaves, homogeneous tobacco, and expanded tobacco; or, the solid substrate may include additional tobacco or non-tobacco volatile aroma compound, which is to be released when the substrate is heated.

In an implementation, the heater 30 may usually include a resistor heating element and an auxiliary base material that assists fixing, manufacturing, or the like of the resistor heating element. For example, in some implementations, the resistor heating element has a spiral coil shape or form. Alternatively, in some other implementations, the resistor heating element is in a form of a conductive trajectory combined with a substrate. Alternatively, in some other implementations, the resistor heating element has a shape of a thin-sheet base material.

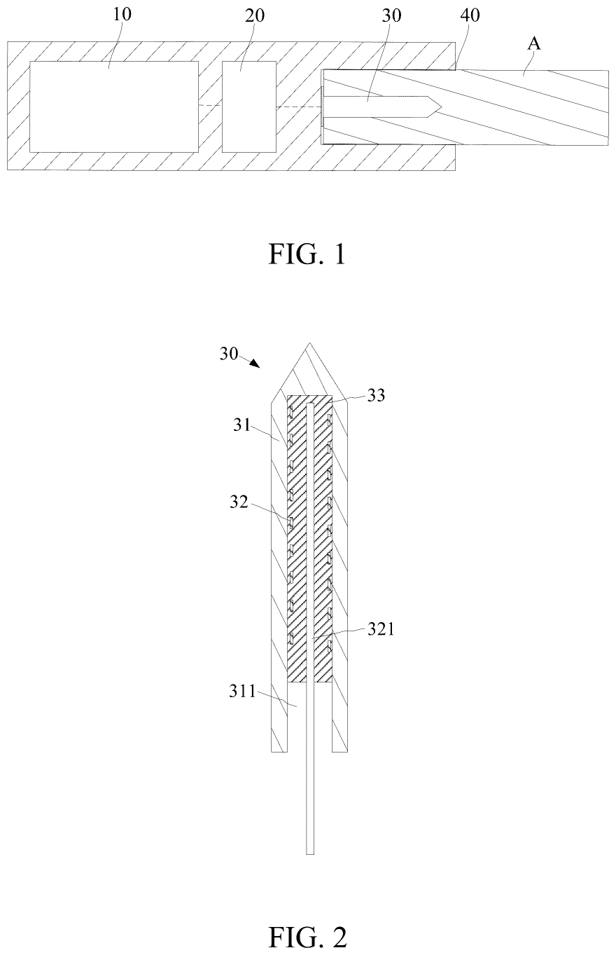

Further, FIG. 2 to FIG. 4 are schematic diagrams of a cross section of the heater 30 and some members in an embodiment, including:
a shell 31, configured into a shape of a pin or needle with a hollow 311, where a front end is a tapered sharp end to facilitate insertion into the aerosol-forming article A, and a rear end has an opening to facilitate assembly of functional members inside the shell; and
a resistor heating element 32, configured to generate heat; and specifically structurally including: a resistor heating coil 320 that is configured into a spiral shape and partially extending in an axial direction of the shell 31 and a first conductive pin 321 that is connected to an upper end of the resistor heating coil 320 and a second conductive pin 322 that is connected to a lower end of the resistor heating coil 320. In use, the first conductive pin 321 and the second conductive pin 322 are configured to supply power to the resistor heating coil 320.

Specifically, according to FIG. 4, the first conductive pin 321 penetrates the resistor heating coil 320 from the upper end of the resistor heating coil 320 to the lower end, to facilitate a connection.

In the implementation shown in FIG. 2, the resistor heating coil 320 is completely assembled and kept in the hollow 311 of the shell 31, and after assembly, the resistor heating coil 320 and the shell 31 conduct heat to each other.

In an optional implementation, a material of the resistor heating coil 320 is a metal material, a metal alloy, graphite, carbon, a conductive ceramic or another composite material of a ceramic material and a metal material that has appropriate impedance. An appropriate metal or alloy material includes at least one of nickel, cobalt, zirconium, titanium, a nickel alloy, a cobalt alloy, a zirconium alloy, a titanium alloy, a nickel-chromium alloy, a nickel-iron alloy, an iron-chromium alloy, an iron-chromium-aluminum alloy, a titanium alloy, an iron-manganese-aluminum-base alloy, stainless steel, and the like.

The shell 31 is made of a thermally conductive metal or alloy material, for example, stainless steel. Certainly, after assembly, the resistor heating coil 320 and an inner wall of the hollow 311 of the shell 31 abut to conduct heat to each other, and at the same time the shell 31 and the resistor heating coil 320 are insulated from each other.

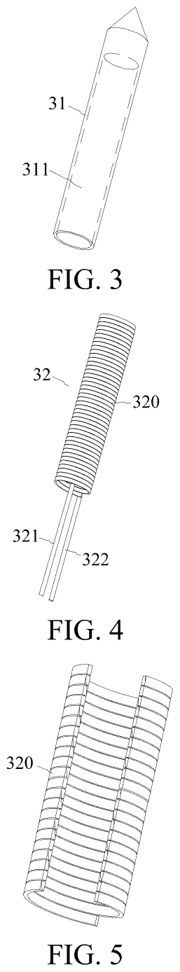

FIG. 5 is a schematic cross-sectional view of the resistor heating coil 320 shown in FIG. 4 from a viewing angle. A shape of a cross section of a wire material of the resistor heating coil 320 is a wide or flat shape different from a conventional circle. In a preferred implementation shown in FIG. 3, a size of the cross section of the wire material of the resistor heating coil 320 extending in a vertical direction is greater than a size extending in a radial direction perpendicular to the vertical direction, to make the resistor heating coil 320 a flat rectangular shape.

Simply speaking, for the resistor heating coil 320 with the foregoing structure, compared with a conventional spiral heating coil formed by wires with a circular cross section, a form of the wire material is completely or at least flattened. Therefore, the wire material extends in the radial direction to a small degree. Through this approach, an energy loss in the resistor heating coil 320 can be reduced. Particularly, the transfer of heat can be facilitated.

In an optional implementation, the first conductive pin 321 and the second conductive pin 322 is made of a material with a low resistance temperature coefficient. In addition, the resistor heating coil 320 is made of a material with a relatively large forward or backward resistance temperature coefficient, so that in use, the circuit 20 may detect a resistance temperature coefficient of the resistor heating coil 320 to obtain a temperature of the resistor heating coil 320.

In still another preferred implementation, the first conductive pin 321 and the second conductive pin 322 are respectively made of two different materials of couple materials such as nickel, nickel-chromium alloy, nickel-silicon alloy, nickelchrome-Kao copper, constantan bronze, and ferrochrome. Further, a thermal couple configured to detect the temperature of the resistor heating coil 320 may be formed between the first conductive pin 321 and the second conductive pin 322, to obtain the temperature of the resistor heating coil 320.

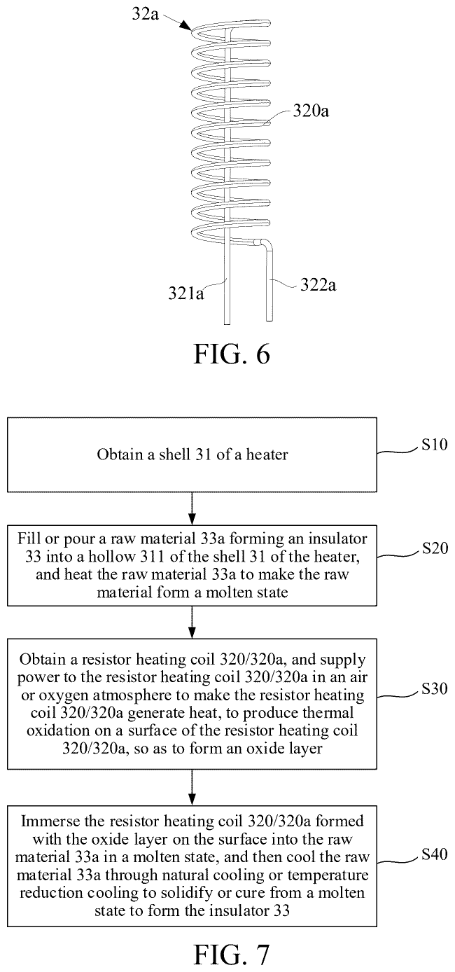

In another variant optional implementation, the resistor heating coil 320 may be made of a conventional wire material with a circular cross section. For example, a resistor heating coil 320a with a spiral coil that is made or constructed using a circular wire material is used in a resistor heating element 32a shown in FIG. 6. In addition, two ends of the resistor heating coil 320a are respectively connected to a first conductive pin 321a and a second conductive pin 322a for power supply or temperature measurement.

In still another optional implementation, for example, as shown in FIG. 2, an insulator 33 is filled or encapsulated in the hollow 311 of the shell 31, and the insulator 33 provide insulation between the resistor heating coil 320/320a and the shell 31. In addition, the insulator 33 further provide support for the resistor heating coil 320/320a.

In an implementation, the resistor heating coil 320/320a is basically completely wrapped or embedded in the insulator 33.

Still another embodiment of this application further provides a manufacturing method of the foregoing heater 30. Referring to FIG. 7, the method includes the following steps.

S10: Obtain a shell 31. Certainly, according to the foregoing description, the shell 31 is a pin or needle having an axial hollow 311. A material is preferably a metal or an alloy, for example, 430 grade stainless steel (SS 430).

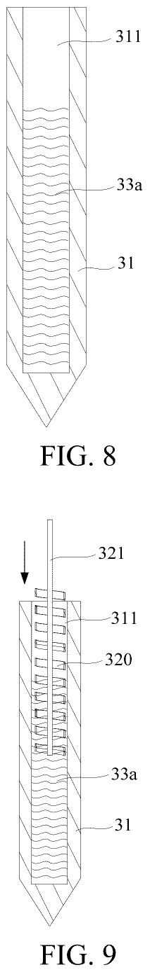

S20: Fill or pour a precursor 33a forming the insulator 33 into the hollow 311 of the shell 31, and heat the precursor 33a to make the precursor form a molten state, as shown in FIG. 8.

S30: Obtain a resistor heating coil 320/320a made of a resistive metal or alloy material, and supply power to the resistor heating coil 320/320a in an air or oxygen atmosphere to make the resistor heating coil 320/320a generate heat, to produce thermal oxidation on a surface of the resistor heating coil 320/320a, so as to form a metal oxide layer located on the surface.

S40: Immerse the resistor heating coil 320/320a formed with the oxide layer on the surface in step S30 into the precursor 33a in a molten state in steps S20, as shown by an arrow in FIG. 9; and then cool the precursor 33a through natural cooling or temperature reduction cooling to solidify or cure from a molten state to form the insulator 33, so that the heater 30 shown in FIG. 2 can be manufactured.

The oxide layer on the surface formed through surface oxidation on the resistor heating coil 320/320a made of a metal or material an alloy material in the foregoing step S30 approximately has a thickness of 10 nm to 100 nm. In an approximate implementation, power is supplied to the resistor heating coil 320/320a to make the resistor heating coil generate heat and dry-burn to 300° C. to 500° C. for approximately 10 min.

Alternatively, in still another alternative implementation, in steps S30, thermal oxidation is caused on the surface of the resistor heating coil 320/320a by heating the resistor heating coil 320/320a in an air or oxygen atmosphere, to form the metal oxide layer located on the surface.

Alternatively, in still another optional implementation, after step S30, the method may further include the following steps.

S31: Further form an insulating material layer on the surface of the resistor heating coil 320/320a through spraying, deposition, sintering, or the like. The insulating material layer is, for example, a glaze layer, a ceramic layer, or the like. This is conducive to further improving insulation effect.

In a preferred implementation, the foregoing precursor 33a of the insulator 33 is preferably a material with a melting point lower than that of the shell 31.

In still another preferred implementation, based on that the shell 31 is usually made of stainless steel, the precursor 33a of the insulator 33 is made of an insulating material with a lower melting point. In the most preferred implementation, the insulator 33 is made of glass or silicon dioxide or glaze. In a manufacturing process, the powder precursor 33a of the insulator is poured into the shell 31 and is heated to 650° C., so that the precursor is molten.

In more other optional implementations, the precursor 33a of the insulator 33 may be made of bismuth oxide with a melting point of approximately 860° C., or boron oxide with a melting point of approximately 450° C., or boron, silicon, or aluminum oxide-containing mixed glass with a melting point of approximately 680° C.

Alternatively, in another variant implementation, when the shell 31 is made of a metal/an alloy or a ceramic with a melting point higher than that of stainless steel, there may be more options for the precursor 33a.

In an implementation, the precursor 33a of the insulator 33 is preferably made of inorganic oxide, carbide, nitride, or an inorganic salt, or the like with a melting point lower than 1500° C. For example, the precursor 33a is made of at least one of aluminum oxide or a precursor thereof, silicon dioxide or a precursor thereof, aluminate, aluminosilicate, aluminum nitride, aluminum carbide, zirconium dioxide, silicon carbide, silicon boride, silicon nitride, titanium dioxide, titanium carbide, boron carbide, boron oxide, borosilicate, silicate, rare earth oxide, soda lime, barium titanate, lead zirconate titanate, aluminum titanate, barium ferrite, strontium ferrite, or this type of inorganic materials, and is relatively easy to obtain and manufacture.

In still another implementation, the precursor 33a of the insulator 33 is preferably made of, doped with or added with a material having a high thermal conduction coefficient, for example, silicon carbide, to enable heat of the resistor heating coil 320/320a to be transferred to the shell 31 more quickly.

In still another implementation, a melting point of the precursor 33a of the insulator 33 is higher than 400° C., to keep the insulator 33 from melting when the heater 30 heats the aerosol-forming article A at a temperature of approximately 400° C. In a more preferred implementation, the melting point of the precursor 33a of the insulator 33 approximately ranges from 600° C. to 1500° C., and preferably may range from 600° C. to 800° C.

As can be seen from the above, the insulator 33 that is cooled and solidified after melting is tightly combined with the shell 31 and/or the resistor heating coil 320/320a. In this case, another support or fixing structure is not required in the heater 30 to provide support or fixing for the resistor heating coil 320/320a and/or the insulator 33.

As a conventional approach in the prior art, during filling of a powder insulating material or filling of an insulating adhesive, an opening of the hollow 311 of the shell 31 needs to be closed or blocked, to avoid a case such as powder leakage or adhesive leakage from an opening of the heater in use. For the heater 30 manufactured by using the foregoing implementation solution, the insulator 33 is obtained through melting and curing and is combined inside a tubular cavity of the shell 31, and there is no problem such as powder leakage or adhesive leakage. In this case, the opening of the hollow 311 of the shell 31 may be kept open or non-closed.

Further, in the foregoing implementation, the insulator 33 is formed through curing from a molten state. In the molten state, the precursor 33a can completely permeate into a gap or an interval between an inner wall of the shell 31 and the resistor heating coil 320/320a. In this way, the insulator 33 basically can safely keep the inner wall of the shell 31 and the resistor heating coil 320/320a in a non-contact state, to further implement basically complete insulation between the shell and the resistor heating coil. Through the foregoing manufacturing steps, the consistency and yield of insulation in mass production and manufacturing can be improved.

In the foregoing manufacturing, high-temperature melting at a higher temperature and sintering at a lower temperature are used. Through melting, the substance of the precursor 33a is changed from a crystal phase into a liquid phase, which is a first-order phase transition. A first-order phase transition does not occur in common sintering. A phase transition using melting can basically completely eliminate internal intervals or pores, which is conducive to improving the thermal capacity of the heater 30 and reducing temperature fluctuations in the heating process. In addition, this further can help to improve the structural strength inside the heater, and reduce powder leakage.

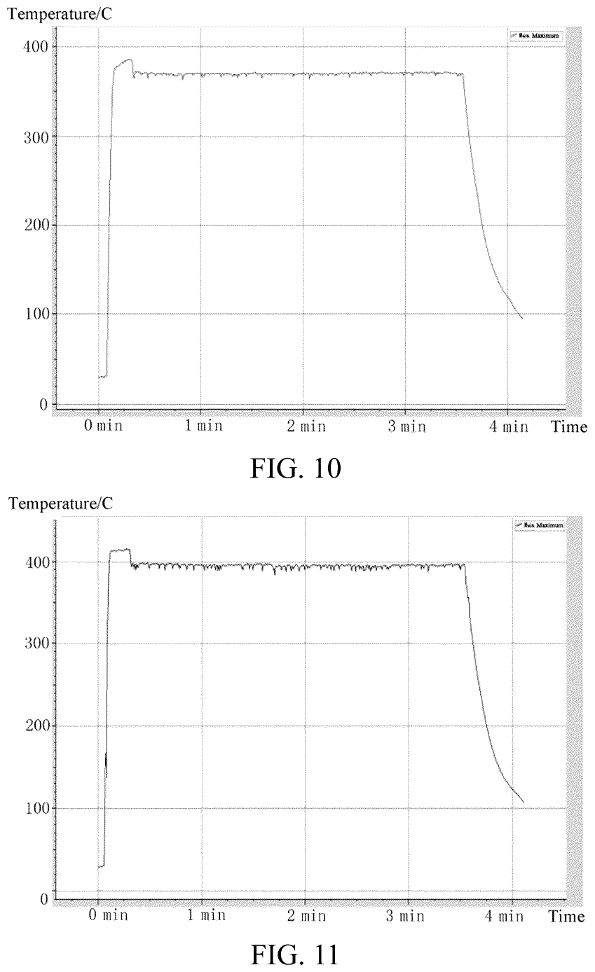

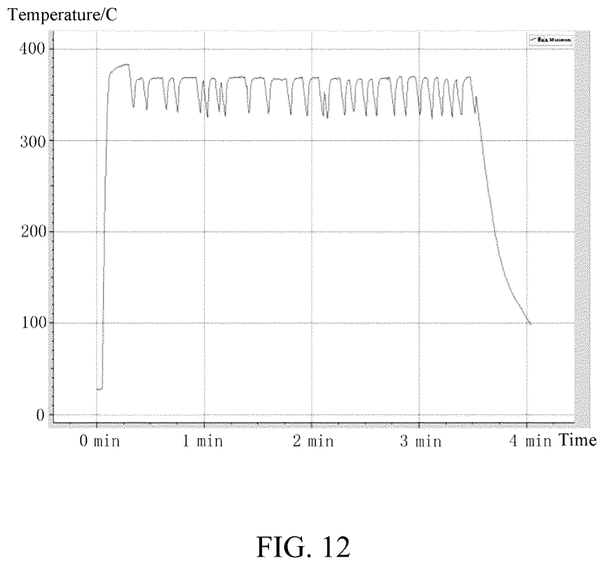

Specifically, FIG. 10 is a temperature change curve of a heater that is cooled and manufactured in a shell 31 of SS 430 stainless steel after a precursor 33a of glass glaze is molten at 800° C. in a use process in an embodiment. FIG. 11 is a temperature change curve of a heater in a use process in a comparative example. The heater is formed through sintering at a temperature of 800° C. after an insulator of a conventional aluminum oxide ceramic slurry is filled in the shell 31 of SS 430 stainless steel. FIG. 12 is a temperature change curve of a heater in a use process in another comparative example. The heater is obtained through manufacturing after diamond powder is filled as the insulator in the shell 31 of SS 430 stainless steel. For all the foregoing curves in use, high precision PID software controls the power of power supply, and further fluctuations at an actual working temperature of the heater are sampled.

As can be seen from the figure, FIG. 12 is a temperature curve of a conventional heater filled with diamond insulation powder. Temperature feedbacks during operation and temperature jump amplitudes in a heating process are relatively large, which approximately range from 30° C. to 50° C. FIG. 11 is a temperature curve of a heater obtained through sintering of an aluminum oxide ceramic slurry. In a heating process, temperature jump amplitudes approximately range from 10° C. to 20° C. FIG. 10 is a temperature curve of a heater using a molten and solidified glaze material as an insulator. In a heating process, temperature jumps are relatively small, and jump amplitudes approximately range from 3° C. to 5° C. In a constant-temperature heating process, the curve is relatively flat.

It should be noted that, the specification of this application and the accompanying drawings thereof illustrate preferred embodiments of this application, but this application is not limited to the embodiments described in the specification. Further, a person of ordinary skill in the art may make improvements or variations according to the foregoing descriptions, and such improvements and variations shall all fall within the protection scope of the appended claims of this application.

1. A vapor generation device, configured to heat an aerosol-forming article to generate an aerosol, and comprising:
a cavity, configured to receive the aerosol-forming article; and
a heater, at least partially extending in the cavity, and configured to heat the aerosol-forming article, wherein the heater comprises:
a shell, having a hollow extending in an axial direction;
a resistor heating element, located in the hollow; and
an insulator, formed by a molten precursor material solidified or cured in the hollow, and configured to provide electrical insulation between the resistor heating element and the shell.

2. The vapor generation device according to claim 1, wherein the shell comprises a metal or an alloy.

3. The vapor generation device according to claim 1, wherein a melting point of the precursor material forming the insulator ranges from 400° C. to 1500° C.

4. The vapor generation device according to claim 1, wherein the melting point of the precursor material is lower than a melting point of the shell.

5. The vapor generation device according to claim 1, wherein the insulator comprises glaze or glass or silicon dioxide.

6. The vapor generation device according to claim 1, wherein the resistor heating element is configured into a form of a spiral coil extending in the axial direction of the hollow; and
a cross section of a wire material of the spiral coil is configured into a flat shape.

7. The vapor generation device according to claim 6, wherein the cross section of the wire material of the spiral coil is configured with a length extending in an axial direction of the spiral coil being greater than a length extending in a radial direction.

8. The vapor generation device according to claim 1, wherein the insulator is configured to keep the resistor heating element in the hollow.

9. The vapor generation device according to claim 1, wherein the resistor heating element is wrapped in the insulator.

10. The vapor generation device according to claim 1, wherein the resistor heating element has a metal oxide layer formed through surface oxidation.

11. A heater for a vapor generation device, wherein the heater comprises:
a shell, comprising a metal or an alloy, wherein the shell is configured into a pin or needle, and has a hollow extending in an axial direction;
a resistor heating element, located in the hollow; and
an insulator, formed by a molten precursor material solidified or cured in the hollow, and configured to provide electrical insulation between the resistor heating element and the shell.

12. A manufacturing method of a heater for a vapor generation device, comprising the following steps:
obtaining shell and a resistor heating element, wherein the shell has a hollow extending in an axial direction; and
solidifying or curing a molten precursor material in the hollow, to provide electrical insulation between the shell and the resistor heating element.

13. The manufacturing method of a heater for a vapor generation device according to claim 12, wherein the step of solidifying or curing a molten precursor material in the hollow comprises:
adding the precursor material to the hollow of the shell, and heating the precursor material to a molten state; and
immersing the resistor heating element in the precursor material in the molten state, and solidifying the precursor material in the molten state through cooling.

14. The manufacturing method of a heater for a vapor generation device according to claim 13, wherein before the immersing the resistor heating element in the precursor material in the molten state, the method further comprises: forming a metal oxide layer on a surface of the resistor heating element.

15. The vapor generation device according to claim 7, wherein the resistor heating element is wrapped in the insulator.

16. The vapor generation device according to claim 15, wherein the resistor heating element has a metal oxide layer formed through surface oxidation.

17. The vapor generation device according to claim 16, wherein the insulator is configured to keep the resistor heating element in the hollow.

18. The vapor generation device according to claim 17, wherein a melting point of the precursor material forming the insulator ranges from 400° C. to 1500° C.

19. The vapor generation device according to claim 18, wherein the melting point of the precursor material is lower than a melting point of the shell.

20. The vapor generation device according to claim 19, wherein the insulator comprises glaze or glass or silicon dioxide.
